(19) United States
(12) Patent Application Publication
(10) Pub. No.: US 2002/0109833 A1
(43) Pub. Date: Aug. 15, 2002

(54) Apparatus for and method of calculating lens distortion factor, and computer readable storage medium having lens distortion factor calculation program recorded thereon

(76) Inventor: Naoki Chiba, Higashi-Osaka City (JP)

Correspondence Address: SMITH, GAMBRELL & RUSSELL, LLP, 1850 M STREET, N.W., SUITE 800, WASHINGTON, DC, 20036, US

(21) Appl. No.: 09/988,630

(22) Filed: Nov. 20, 2001

(30) Foreign Application Priority Data
Nov. 27, 2000 (JP) 2000-358823

(51) Int. Cl. G01B 9/00

(52) U.S. Cl. 356/124

(57) ABSTRACT

A lens distortion factor calculating apparatus for subjecting an image picked up by image pick-up means having a lens to lens distortion correction comprises first means for finding, on the basis of two images picked up by the image pick-up means, the coordinates of a plurality of corresponding points between the images, second means for calculating, on the basis of the coordinates of the corresponding points found by the first means, geometric transform factors between the two images and third means for calculating, on the basis of the coordinates of the corresponding points found by the first means and the geometric transform factors found by the second means, a lens distortion factor.

### BACKGROUND OF THE INVENTION

1. Field of the Invention

The present invention relates to an apparatus for and a method of calculating a lens distortion factor, a computer readable recording medium having a lens distortion factor calculation program recorded thereon, an apparatus for and a method of combining images, and a recording medium having an image constructing program recorded thereon.

2. Description of the Prior Art

[1] Description of Conventional Method of Calculating Optical Flow

A technique for calculating an optical flow from two images, and registering the two images on the basis of the obtained optical flow has been known. Description is made of a conventional method of calculating an optical flow.

(1) Lucas-Kanade Method

A large number of methods for calculating the apparent optical flow of a moving object in a moving image have been conventionally proposed. The Lucas-Kanade method which is a local gradient method out of the methods is one of the best methods. The reason for this is that the speed of processing is high, implementing is easy, and the result has confidence.

As for the details of the Lucas-Kanade method, see an article entitled by B. Lucas and T. Kanade, “An Iterative Image Registration Technique with an Application to Stereo Vision”, In Seventh International Joint Conference on Artificial Intelligence (IJCAI-81), pp. 674-979, 1981.

The outline of the Lucas-Kanade method will be described below.

When a gray scale pattern I (x, y, t) of image coordinates p=(x, y) at time t is moved to coordinates (x+δx, y+δy) with its gradation distribution kept constant after a very small time period (δt), the following optical flow constraint equation (1) holds:

$$\frac{\partial I}{\partial x} \frac{δx}{δ t} + \frac{\partial I}{\partial y} \frac{δy}{δ t} + \frac{\partial I}{\partial t} = 0 \qquad ( 1 )$$

In order to calculate an optical flow {v=(δx/δt, δy/δt)=(u, v) } in a two-dimensional image, another constraint equation is required because the number of unknown parameters is two. Lucas and Kanade have assumed that the optical flow is constant in a local region of an object.

Suppose the optical flow is constant within a local region a) on an image, for example. In this case, a squared error E of a gray scale pattern which is to be minimized can be defined by the following equation (2) when the following substitutions are made:

$${I}_{0} ( p ) = I ( x , y , t ) , \\ {I}_{1} ( p + v ) = I ( x + u , y + v , t + δ t ) \\ E = {\sum }_{ω} {[ {I}_{1} ( p + v ) - {I}_{0} ( p ) ]}^{2} \qquad ( 2 )$$

When v is very small, the terms of second and higher degrees in Tailor series expansion can be ignored. Therefore, a relationship expressed by the following equation (3) holds:

I₁(p+v)=I₁(p)+g(p)v (3)

where g(p) is a linear differential of I₁(p)

The error E is minimized when the derivative of E with respect to v is zero. Therefore, a relationship expressed by the following equation (4) holds:

$$0 = \frac{\partial }{\partial v} E \\ \approx \frac{\partial }{\partial v} {\sum }_{ω} {[ {I}_{1} ( p ) + g ( p ) v - {I}_{0} ( p ) ]}^{2} \\ = {\sum }_{ω} 2 g ( p ) [ {I}_{1} ( p ) + g ( p ) v - {I}_{0} ( p ) ] \qquad ( 4 )$$

Therefore, the optical flow v is found by the following equation (5):

$$v \approx \frac{{\sum }_{ω} g ( p ) [ {I}_{0} ( p ) - {I}_{1} ( p ) ]}{{\sum }_{ω} {g ( p )}^{2}} \qquad ( 5 )$$

Furthermore, the optical flow can be found with high precision by Newton-Raphson iteration, as expressed by the following equation (6):

$${v}_{k + 1} = {v}_{k} + \frac{\sum {g}_{k} [ {I}_{0} - {I}_{1}^{k} ]}{\sum {( {g}_{k} )}^{2}} \\ {I}_{1}^{k} = {I}_{1} ( p + {v}_{k} ) , \\ {g}_{k} = g ( p + {v}_{k} ) , \\ {I}_{0} = {I}_{0} ( p ) \qquad ( 6 )$$

Iₗ^{k}=I₁(p+vₖ), (6)

gₖ=g(p+vₖ),

I₁=I₀(p)

(2) Hierarchical Estimation Method

The largest problem of the gradient methods, including the Lucas-Kanade method, is that the methods cannot be applied to a large motion because a good initial value is required. Therefore, a method of producing images respectively having resolutions which differ at several levels like a pyramid hierarchical structure to solve the problem has been conventionally proposed.

Images having resolutions which differ at several levels are first previously produced from each of two consecutive images. An approximate optical flow is then calculated between the images having the lowest resolution. Amore precise optical flow is calculated between images having resolutions which are higher by one level with reference to the results. The processing is successively repeated until the optical flow is calculated between the images having the highest resolution.

FIG. 4, FIG. 3, FIG. 2, and FIG. 1 respectively illustrate an original image, an image having a lower resolution than that of the original image shown in FIG. 4, an image having a lower resolution than that of the image having a low resolution shown in FIG. 3, and an image having a lower resolution than that of the image having a low resolution shown in FIG. 2. In FIGS. 1 to 4, S denotes one patch.

An optical flow is gradually found from the image shown in FIG. 1 (an image in a hierarchy 1) the image shown in FIG. 2 (an image in a hierarchy 2), the image shown in FIG. 3 (an image in a hierarchy 3), and the image shown in FIG. 4 (an image in a hierarchy 4) in this order. In FIGS. 1 to 4, an arrow indicates an optical flow vector found for each patch.

However, the problem herein is that in a real image, there are few regions containing sufficient texture, so that a reliable optical flow is not obtained.

[2] Description of Optical Flow Calculating Method Developed by Applicant of Present Invention

An optical flow calculating method developed by the applicant of the present invention presupposes hierarchical prediction for producing images having resolutions which differ at several levels like a pyramid hierarchical structure to gradually calculate an optical flow. A method of calculating an optical flow conforms to a gradient method such as the Lucas-Kanade method. That is, it presupposes an optical flow estimation method using a hierarchically structured gradient method. The Lucas-Kanade method is used as the gradient method.

The optical flow estimation method developed by the applicant of the present invention is characterized in that an optical flow obtained in each of stages of the optical flow estimation method using the hierarchically structured Lucas-Kanade method is filled by dilation processing. This will be described in detail below.

One of advantages of the Lucas-Kanade method is that the result of tracking has confidence. Tomasi and Kanade have showed that the trackability of a region can be calculated from image derivatives as follows (C. Tomasi and T. Kanade, “Shape and Motion from Image Streams; a Factorization method-Part 3 Detection and Tracking of Point Features”, CMU-CS-91-132, Carnegie Mellon University, 1991).

From a 2×2 matrix of coefficients G in the following equation (7) having as elements the squares of differentials in the vertical and horizontal directions of an image ω in a region, its eigenvalues are calculated, thereby making it possible to determine the trackability of the region:

$$G = {\sum }_{p ∈ ω} g ( p ) {g ( p )}^{T} \qquad ( 7 )$$

When both the eigenvalues of the matrix G are large, the region changes in orthogonal directions, and can be uniquely positioned. Consequently, the confidence γ of the result of tracking can be obtained by the following equation (8) from the smaller eigenvalue λₘᵢₙ and a gray scale residual E between the regions after the tracking:

$$γ = \frac{{λ}_{min}}{E} \qquad ( 8 )$$

The inventors and others of the present invention have developed a method of interpolating a region having low confidence using the result having high confidence in the same hierarchy in an optical flow. This uses the result in a hierarchy at the next coarser resolution level for only an initial value for tracking and does not utilize the result in a hierarchy at the current resolution level which is paid attention to. Alternatively, it is assumed that an optical flow in a region which is hardly textured has a value close of optical flows in its surrounding regions, to fill a flow field by morphology processing.

FIG. 5 shows how flow vector dilation processing is performed.

The left drawing indicates a map of the confidence of a flow vector on a gray scale. It is assumed that the blacker the map is, the higher the confidence is.

Obtained flow is first subjected to threshold processing. A white portion is subjected to threshold processing because the result has low confidence.

The dilation processing of the result in the flow field is then performed as follows in imitation of hole filling processing using a morphology operation in a binary image. A flow vector u (i, j ) in coordinates i, j of a region can be calculated, as expressed by the following equation (9), upon being weighted depending on confidence γ from flow vectors in its four vicinities:

$$u ( i , j ) = {\sum }_{p , q} \frac{γ ( i + p , j + q ) \times u ( i + p , j + q )}{{γ}_{A}} \\ ( p , q ) = ( 0 , 1 ) , ( 0 , - 1 ) , ( - 1 , 0 ) ( 1 , 0 ) \\ {γ}_{A} = {\sum }_{p , q} γ ( i + p , j + q ) \qquad ( 9 )$$

(p, q)=(0,1),(0,−1),(−1,0)(1,0)

The processing is repeated until all regions having low confidence which have been subjected to threshold processing are filled. The filling processing is performed in each hierarchy. The flow vector u(i, j) in the coordinates i, j of the region may be calculated upon being weighted depending on confidence γ from flow vectors in its eight vicinities.

FIG. 6a shows optical flow which has been subjected to threshold processing for an image in a hierarchy, and FIG. 6b shows optical flow after filling. In FIG. 6a, arrows are optical flow vectors whose confidence is judged to be high by the threshold processing, and X marks indicate portions whose confidence is judged to be low.

[3] Description of Conventional Method of Producing Panoramic Image

The applicant and others of the present invention have already developed a method of producing a panoramic image by calculating geometric parameters between a plurality of images and composing the images on the basis of the calculated geometric parameters (see JP-A-11-339021).

This time, the applicant of the present invention has proposed a lens distortion calibrating method in order to obtain a higher precision panoramic image. In a conventional lens distortion calibrating method, a special calibrating pattern has been prepared, to pick up a plurality of images with the calibrating pattern, and calculate a lens distortion factor on the basis of obtained images (a document entitled by Z. Zhang “Flexible camera calibration by viewing a plane from unknown orientations”, Proc. ICCV99. pp.666-673, 1999).

However, it is difficult for a user to calibrate lens distortion using a calibrating pattern.

### SUMMARY OF THE INVENTION

An object of the present invention is to provide a lens distortion factor calculating apparatus, a lens distortion factor calculating method, and a computer readable recording medium having a lens distortion factor calculation program recorded thereon, in which lens distortion can be calibrated without using a calibrating pattern.

Another object of the present invention is to provide an image constructor, an image constructing method, and a recording medium having an image constructing program recorded thereon, in which a high precision panoramic image is obtained.

In a lens distortion factor calculating apparatus for subjecting an image picked up by image pick-up means having a lens to lens distortion correction, a lens distortion factor calculating apparatus according to the present invention is characterized by comprising first means for finding, on the basis of two images picked up by the image pick-up means, the coordinates of a plurality of corresponding points between the images; second means for calculating, on the basis of the coordinates of the corresponding points found by the first means, geometric transform factors between the two images; and third means for calculating, on the basis of the coordinates of the corresponding points found by the first means and the geometric transform factors found by the second means, a lens distortion factor.

An example of the first means is one comprising means for extracting an overlapped portion of the two images picked up by the image pick-up means, means for extracting, from the overlapped portion of one of the images with the other image, a plurality of partial images effective for tracking by an optical flow between both the images as feature points, and means for tracking a point, which corresponds to each of the feature points on the one image, on the other image on the basis of the optical flow between both the images.

In a lens distortion factor calculating method for subjecting an image picked up by image pick-up means having a lens to lens distortion correction, a lens distortion factor calculating method according to the present invention is characterized by comprising a first step of finding, on the basis of two images picked up by the image pick-up means, the coordinates of a plurality of corresponding points between the images; a second step of calculating, on the basis of the coordinates of the corresponding points found in the first step, geometric transform factors between the two images; and a third step of calculating, on the basis of the coordinates of the corresponding points found in the first step and the geometric transform factors found in the second step, a lens distortion factor.

An example of the first step is one comprising the steps of extracting an overlapped portion of the two images picked up by the image pick-up means, extracting, from the overlapped portion of one of the images with the other image, a plurality of partial images effective for tracking by an optical flow between both the images as feature points, and tracking a point, which corresponds to each of the feature points on the one image, of the other image on the basis of the optical flow between both the images.

A computer readable recording medium having a lens distortion factor calculation program recorded thereon according to the present invention is a computer readable recording medium having a lens distortion factor calculation program for subjecting an image picked up by image pick-up means having a lens to lens distortion correction recorded thereon, characterized in that the lens distortion factor calculation program causes a computer to carry out a first step of finding, on the basis of two images picked up by the image pick-up means, the coordinates of a plurality of corresponding points between the images; a second step of calculating, on the basis of the coordinates of the corresponding points found in the first step, geometric transform factors between the two images; and a third step of calculating, on the basis of the coordinates of the corresponding points found in the first step and the geometric transform factors found in the second step, a lens distortion factor.

An example of the first step is one comprising the steps of extracting an overlapped portion of the two images picked up by the image pick-up means, extracting, from the overlapped portion of one of the images with the other image, a plurality of partial images effective for tracking in an optical flow between both the images as feature points, and tracking a point, which corresponds to each of the feature points on the one image, on the other image on the basis of the optical flow between both the images.

In an image constructor for combining a first image and a second image which are picked up by image pick-up means having a lens, an image constructor according to the present invention is characterized by comprising first means for finding, on the basis of the first image and the second image, the coordinates of a plurality of corresponding points between the images; second means for calculating, on the basis of the coordinates of the corresponding points found by the first means, geometric transform factors between the first image and the second image; third means for calculating, on the basis of the coordinates of the corresponding points found by the first means and the geometric transform factors found by the second means, a lens distortion factor; fourth means for subjecting the first image and the second image to lens distortion correction on the basis of the lens distortion factor calculated by the third means; and fifth means for combining the first image and the second image, which have been subjected to the lens distortion correction, obtained by the fourth means using the geometric transform factors between the first image and the second image which have been subjected to the lens distortion correction.

An example of the first means is one comprising means for extracting an overlapped portion of the first image and the second image, means for extracting, from the overlapped portion of one of the images with the other image, a plurality of partial images effective for tracking by an optical flow between both the images as feature points, and means for tracking a point, which corresponds to each of the feature points on the one image, on the other image on the basis of the optical flow between both the images.

In an image construcging method for combining a first image and a second image which are picked up by image pick-up means having a lens, an image constructing method according to the present invention is characterized by comprising a first step of finding, on the basis of the first image and the second image, the coordinates of a plurality of corresponding points between the images; a second step of calculating, on the basis of the coordinates of the corresponding points found in the first step, geometric transform factors between the first image and the second image; a third step of calculating, on the basis of the coordinates of the corresponding points found in the first step and the geometric transform factors found in the second step, a lens distortion factor; a fourth step of subjecting the first image and the second image to lens distortion correction on the basis of the lens distortion factor calculated in the third step; and a fifth step of combining the first image and the second image, which have been subjected to the lens distortion correction, obtained in the fourth step using the geometric transform factors between the first image and the second image which have been subjected to the lens distortion correction.

An example of the first step is one comprising the steps of extracting an overlapped portion of the first image and the second image, extracting, from the overlapped portion of one of the images with the other image, a plurality of partial images effective for tracking by an optical flow between both the images as feature points, and tracking a point, which corresponds to each of the feature points on the one image, on the other image on the basis of the optical flow between both the images.

A computer readable recording medium having an image constructing program according to the present invention is a computer readable recording medium having an image constructing program for combining a first image and a second image which are picked up by image pick-up means having a lens recorded thereon, characterized in that the image constructing program causes a computer to carry out a first step of finding, on the basis of the first image and the second image, the coordinates of a plurality of corresponding points between the images; a second step of calculating, on the basis of the coordinates of the corresponding points found in the first step, geometric transform factors between the first image and the second image; a third step of calculating, on the basis of the coordinates of the corresponding points found in the first step and the geometric transform factors found in the second step, a lens distortion factor; a fourth step of subjecting the first image and the second image to lens distortion correction on the basis of the lens distortion factor calculated in the third step; and a fifth step of combining the first image and the second image, which have been subjected to the lens distortion correction, obtained in the fourth step using the geometric transform factors between the first image and the second image which have been subjected to the lens distortion correction.

An example of the first step is one comprising the steps of extracting an overlapped portion of the first image and the second image, extracting, from the overlapped portion of one of the images with the other image, a plurality of partial images effective for tracking by an optical flow between both the images as feature points, and tracking a point, which corresponds to each of the feature points on the one image, on the other image on the basis of the optical flow between both the images.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view for explaining a hierarchical estimation method, which illustrates an image in a hierarchy 1;

FIG. 2 is a schematic view for explaining a hierarchical estimation method, which illustrates an image in a hierarchy 2;

FIG. 3 is a schematic view for explaining a hierarchical estimation method, which illustrates an image in a hierarchy 3;

FIG. 4 is a schematic view for explaining a hierarchical estimation method, which illustrates an image in a hierarchy 4;

FIG. 5 is a schematic view for explaining dilation processing performed in an optical flow estimation method employed in the present embodiment;

FIG. 6a is a schematic view showing an example of an optical flow which has been subjected to threshold processing for an image in a hierarchy, and FIG. 6b is a schematic view showing an optical flow after completion;

FIG. 7 is a block diagram showing the configuration of a panoramic image constructor; and

FIG. 8 is a flow chart showing the procedure for panoramic image constructing processing;

FIG. 9 is a flow chart showing the detailed procedure for processing in the step 2 shown in FIG. 8; and

FIG. 10 is an illustration for explaining a planar projective transform.

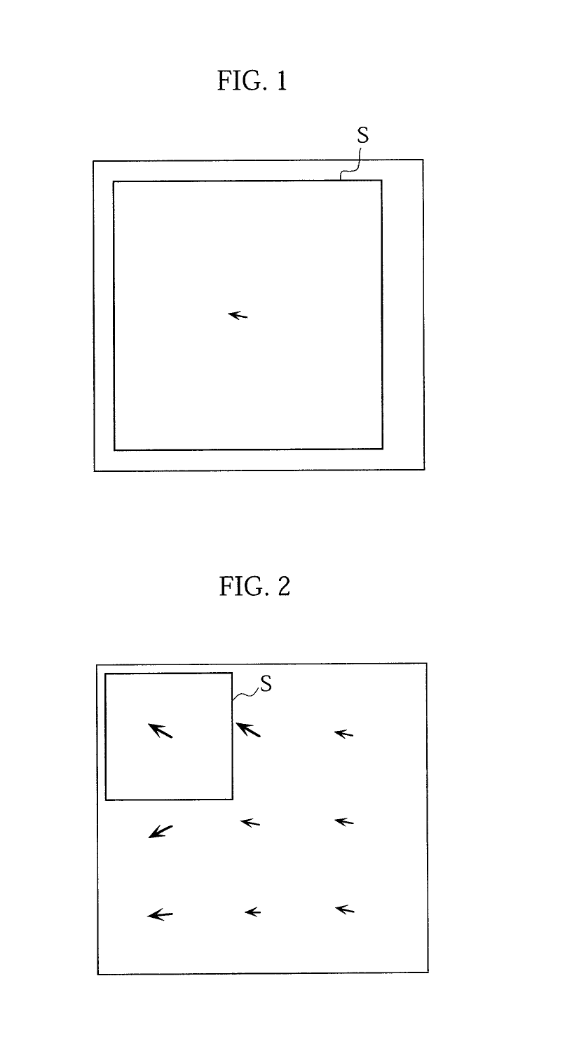

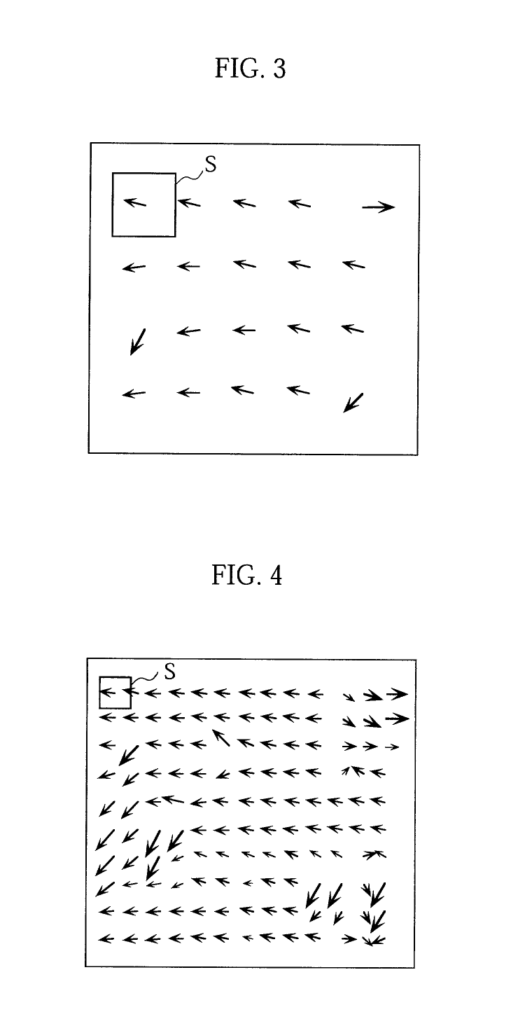

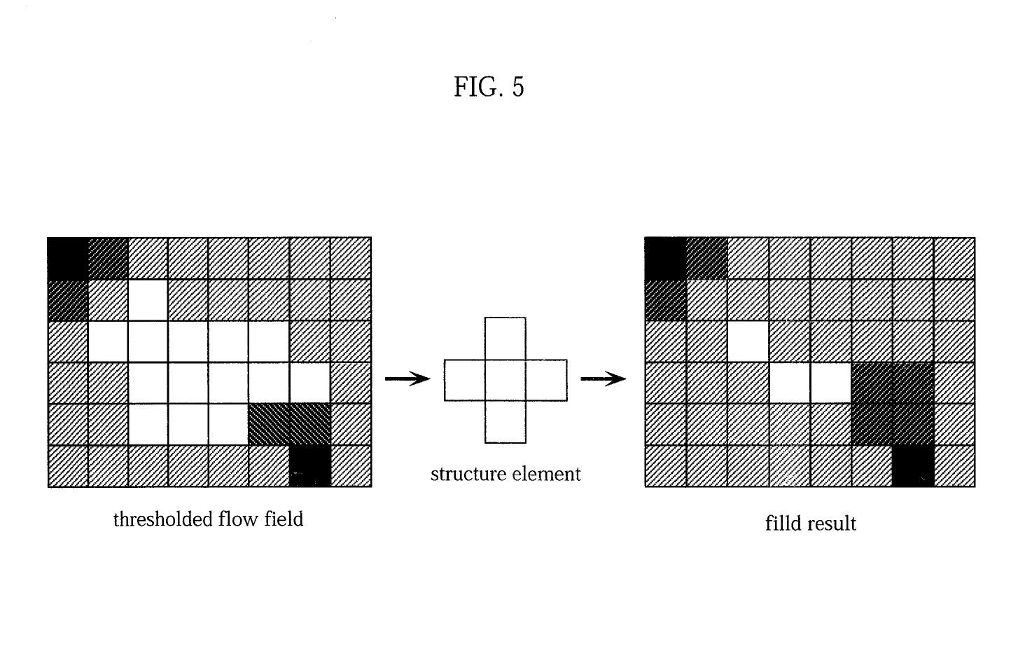

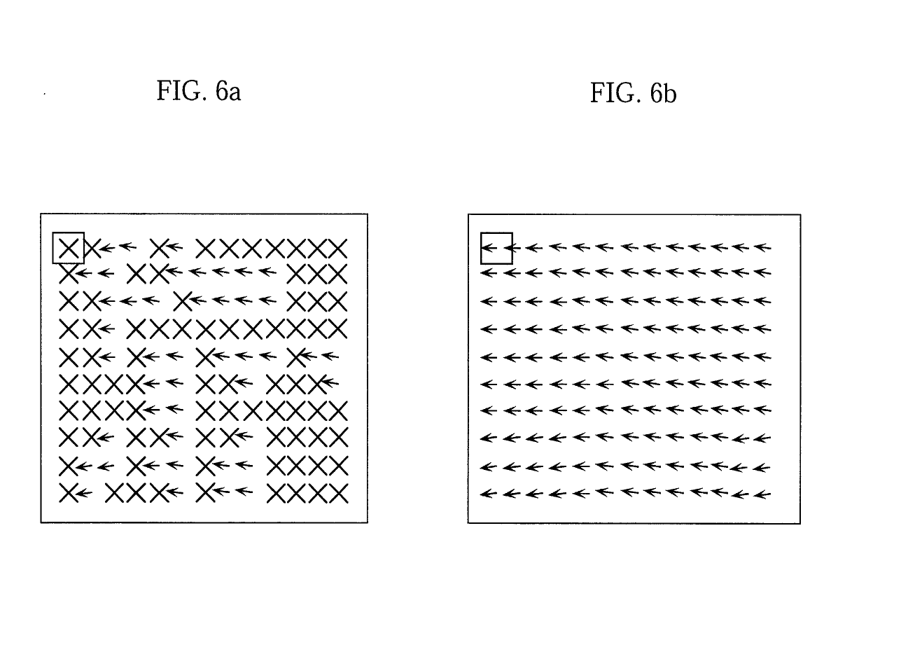

### DESCRIPTION OF THE PREFERRED EMBODIMENTS

Description is now made of an embodiment in a case where the present invention is applied to a panoramic image constructor.

[1] Description of Panoramic Image Constructor

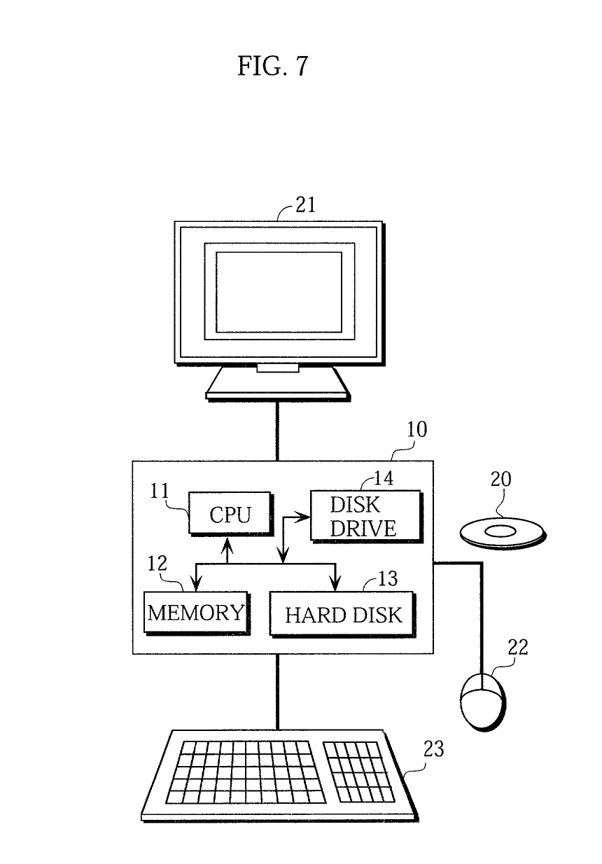

FIG. 7 illustrates the configuration of a panoramic image constructor.

The panoramic image constructor is realized by a personal computer. A display 21, a mouse 22, and a keyboard 23 are connected to a personal computer 10. The personal computer 10 comprises a CPU 11, a memory 12, a hard disk 13, a drive (a disk drive) 14 of a removable disk such as CD-ROM.

The hard disk 13 stores a panoramic image constructing processing program in addition to OS (Operating System). The panoramic image constructing processing program is installed in the hard disk 13 using a CD-ROM 20 storing the program. It is assumed that a plurality of images picked up by a digital camera are previously stored in the hard disk 13.

[2] Description of Panoramic Image Constructing Processing Performed by CPU 11 in Case Where Panoramic Image Constructing Program is Started

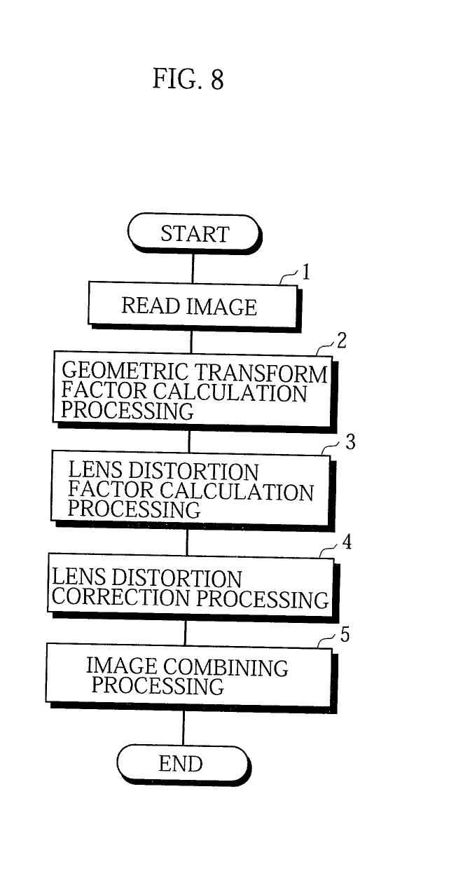

FIG. 8 shows the procedure for overall processing performed by the CPU 11.

For convenience of illustration, description is herein made of a case where two images are combined to construct a panoramic image.

Two images to be combined are first read in the memory 12 (step 1).

Geometric transform factors between the read two images are calculated (step 2).

A lens distortion factor is then calculated (step 3). In this case, geometric transform parameters are corrected on the basis of the lens distortion factor.

The two images are subjected to lens distortion correction processing on the basis of the calculated lens distortion factor (step 4).

The two images which have been subjected to the lens distortion correction processing are combined on the basis of the two images and the geometric transform parameters corrected on the basis of the lens distortion factor (step 5).

Each of the steps 2 to 5 will be described in more detail.

[3] Description of Processing in Step 2 Shown in FIG. 8

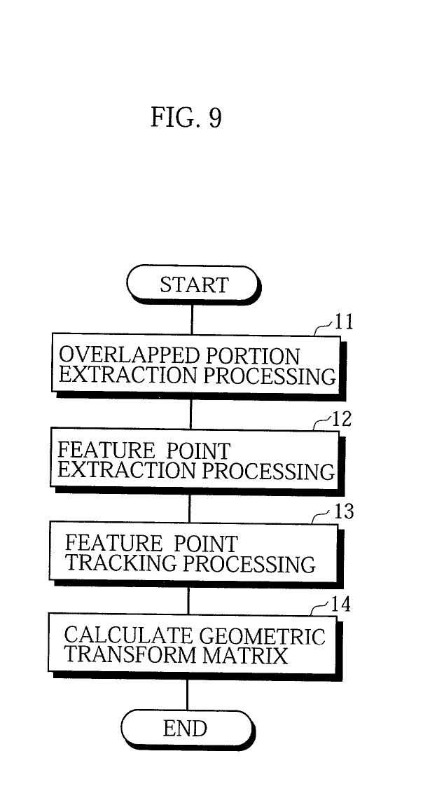

FIG. 9 shows the detailed procedure for the processing in the step 2 shown in FIG. 8.

For convenience of illustration, description is herein made of a case where two images which have an overlapped portion (a first image A1 and a second image A2) are joined to each other.

First, extraction processing of the overlapped portion of the first image A1 and the second image A2 is performed (step 11). The extraction processing of the overlapped portion is performed on the basis of the SSD (Sum of Squared Difference) method or the normalized correlation method, for example.

(a) Description of SSD Method

In the SSD method, with respect to two original images A1 and A2 whose overlapped portion should be extracted, images I₁ and I₂ having lower resolutions than those of the original images are first respectively produced. An overlapped portion ω (size: M×N) of the two images I₁ and I₂ having low resolutions is found using a squared error E per pixel, as expressed by the following equation (10). An amount of movement (d) between the images is changed in an allowable range, and the overlapped portion is extracted from the amount of movement (d) in a case where E is the smallest:

$$E ( d ) = \frac{{\sum }_{ω} {( {I}_{1} ( x ) - {I}_{2} ( x + d ) )}^{2}}{M \times N} \qquad ( 10 )$$

(b) Description of Normalized Cross-correlation Method

In the normalized cross-correlation method, with respect to two original images A1 and A2 whose overlapped portion should be extracted, images I₁ and I₂ having lower resolutions than those of the original images are first respectively produced. The overlapped portion ω (size: M×N) of the two images I₁ and I₂ having low resolution is found using a normalized cross-correlation factor C, as expressed by the following equation (11). An amount of movement (d) between the images is changed in an allowable range, and the overlapped portion is extracted from the amount of movement (d) in a case where C is the largest:

$$C ( d ) = \frac{{\sum }_{ω} ( {I}_{1} ( x ) - {\overline{I}}_{1} ) ( {I}_{2} ( x + d ) - {\overline{I}}_{2} )}{\sqrt{{σ}_{1} \cdot {σ}_{2}}} \qquad ( 11 )$$

In the equation (11), \overline{I₁} and \overline{I₂} are averages of respective gray scale values of a first image I₁ and a second image I₂ in the overlapped portion of both the images in a case where the first image is fixed and the second images is moved by d. σ₁ and σ₂ are respective variances of the gray scale values of the first image I₁ and the second image I₂ in the overlapped portion of both the images in a case where the first image I₁ is fixed and the second image I₂ is moved by d.

Feature point extraction processing is then performed (step 12). That is, a plurality of partial images (rectangular regions) which are effective for tracking are extracted as feature points from the overlapped portion of the first image A1 with the second image A2. The feature points are extracted such that they are not overlapped with each other. Specifically, the above-mentioned portion having a high eigenvalue λₘᵢₙ (see the equation (8) ) is extracted as the feature point.

Feature point tracking processing is then performed (step 13). That is, a position, on the second image A2, of the extracted feature point on the first image A1 is tracked.

Specifically, an optical flow vector for each patch of suitable size (13×13, for example) is first found by the optical flow estimating method developed by the applicant of the present invention (see [2] in column “Description of the Prior Art”). The position, on the second image A2 corresponding to the feature point on the first image A1 is found in units not exceeding units of pixels by linear interpolation from flow vectors in the patches in four vicinities of the feature point on the first image A1. Consequently, in the overlapped portion of the first image A1 and the second image A2, the coordinates of each of corresponding points on both the images are obtained.

A geometric transform matrix (geometric transform factors) is then calculated (step 14).

As the geometric transform factors, a planar projective transform matrix is used herein. Affine transformation, 2D rigid transform, 2D translation, and so forth may be used as geometric transformation depending on imaging conditions.

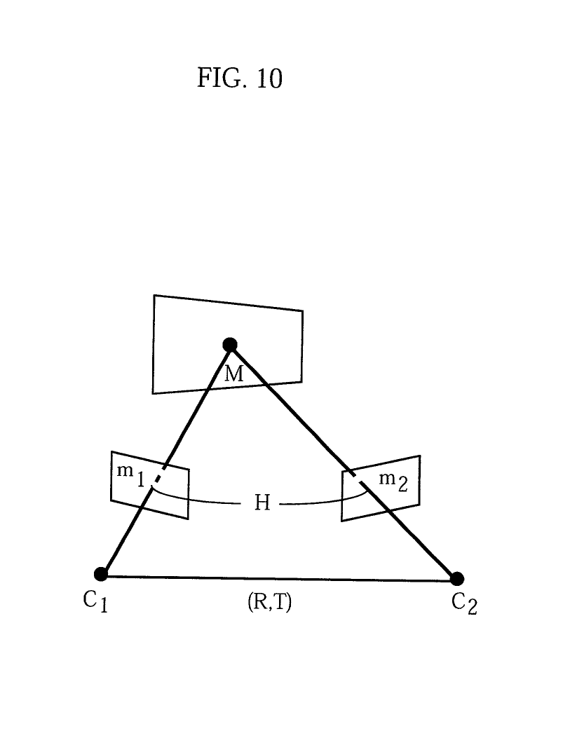

When a scene to be an object is far, or is a wall of a building or a blackboard, or the like even if it is near, it can be assumed that the scene exists on a simple plane. It is known in projective geometry that when a point M on a single plane in a three-dimensional space is observed from two different view points C₁ and C₂, as shown in FIG. 10, transformation between coordinates m₁ and m₂ on their respective image surfaces is linear, which is referred to as homography (O. Faugeras. “Three-Dimension Computer Viaion: a Geometric Viewpoint”, MIT press, 1993.).

That is, in a case where the coordinates of an image are represented by homogeneous coordinates, a point m₂=(X₂, y₂, 1) on the second image has a corresponding point m₁=(x₁, y₁, 1)^{t} on the first image, and the relationship therebetween is defined by the following equation (12):

$${m}_{1} \sim {Hm}_{2} = ( \begin{matrix}{h}_{0} & {h}_{1} & {h}_{2} \\ {h}_{3} & {h}_{4} & {h}_{5} \\ {h}_{6} & {h}_{7} & 1\end{matrix} ) ( \begin{matrix}{x}_{2} \\ {y}_{2} \\ 1\end{matrix} ) \qquad ( 12 )$$

indicates projective equivalence, leaving a scale factor. The transform matrix H can be rewritten, as expressed by the following equation (13)

$${x}_{1} = \frac{{h}_{0} {x}_{2} + {h}_{1} {y}_{2} + {h}_{2}}{{h}_{6} {x}_{2} + {h}_{7} {y}_{2} + 1} \\ {y}_{1} = \frac{{h}_{3} {x}_{2} + {h}_{4} {y}_{2} + {h}_{5}}{{h}_{6} {x}_{2} + {h}_{7} {y}_{2} + 1} \qquad ( 13 )$$

[4] Description of Processing (Lens Distortion Factor Calculation Processing) in Step 3 in FIG. 8

Lens distortion means such a phenomenon that a lens is geometrically distorted depending on the distance from the center of lens distortion. Coordinates on an image plane shall be referred to as image coordinates. Letting (uₜ, vₜ) be true image coordinates including no lens distortion, actually observed image coordinates (uₐ, vₐ) including lens distortion can be generally expressed by the following equation (14):

uₐ=uₜ+(uₜ−uₒ)kr²

vₐ=vₜ+(vₜ−v₀)kr² (14)

r²(uₜ−u₀)²+(uₜ−v₀)²

In the foregoing equation (14), k is a distortion factor, and (uₒ, vₒ.) are the coordinates at the center of lens distortion.

Letting Pᵢ be the coordinates of each feature point in the first image A1, P′ᵢ be coordinates corresponding thereto on the second image A2, and H be a geometric transform matrix between both the images, an error function E can be defined, as expressed by the following equation (15):

$$E = {\sum }_{i} {( {p}_{i} - H ( {p}_{i}^{′} ) )}^{2} \qquad ( 15 )$$

If it is assumed that the coordinate (uₒ, vₒ) at the center of lens distortion coincides with the center of an image, the error function E can be rewritten, as expressed by the following equation (16), using the distortion factor k in the foregoing equation (14):

$$E = {\sum }_{i} {( {p}_{i} ( k ) - H ( {p}_{i}^{′} ( k ) ) )}^{2} \qquad ( 16 )$$

The lens distortion factor k for minimizing the error E is calculated using the Newton-Raphson method. That is, in a case where a variance dk of the factor k is very small, when the terms of second and higher degrees are ignored by Tailor series expansion, the following equation (17) is obtained:

E(k+dk)=E(k)+dkE′(k) (17)

where E′ is a linear differential of the error function E. Since it is desired to find the minimum value of E, the following equation (18) is obtained:

E(k+dk)=0 (18)

When the foregoing equation (18) is substituted in the foregoing equation (17), dk can be calculated by the following equation (19):

$$dk = - \frac{E ( k )}{{E}^{′} ( k )} \qquad ( 19 )$$

Furthermore, dk can be calculated with higher precision by iteration, as expressed by the foregoing equation (20):

$${dk}_{i + 1} = {dk}_{i} - \frac{E ( {k}_{i + 1} )}{{E}^{′} ( {k}_{i + 1} )} \qquad ( 20 )$$

That is, dk₀, dk₁, dk₂, . . . dkₙ are successively found, taking a starting point as k=0. When dk₀ is calculated, a matrix (which is taken as H₀) calculated in the step 2 is used as the geometric transform matrix H in the foregoing equation (16) When dk₀ is found, corresponding points (feature points) between the first image A1 and the second image A2 which are used for calculating the geometric transform matrix H are subjected to lens distortion correction on the basis of the foregoing equation (14), to newly calculate a geometric transform matrix H₁ from the corresponding points which have been subjected to the lens distortion correction.

In calculating dk₁, the geometric transform matrix H₁ newly calculated is used as the geometric transform matrix H in the foregoing equation (16). The same is true for a case where dk₂ and later are calculated. A geometric transform matrix Hₙ is newly calculated on the basis of dkₙ (=k) finally found.

In finding dk₀ dk₁, dk₂, dkₙ, the matrix H calculated in the step 2 may be always used as the geometric transform matrix H in the foregoing equation (16). Also in this case, the geometric transform matrix Hₙ is newly calculated on the basis of dkₙ (=k) finally found.

[5] Description of Processing (Lens Distortion Correction Processing) in Step 4 in FIG. 8

In the lens distortion correction processing in the step 4, images A1′ and A2′ in which lens distortion has been corrected are produced from the first image A1 and the second image A2 on the basis of the lens distortion factor dk (=k) finally found in the step 3 and the foregoing equation (14).

That is, letting (uₜ, vₜ) be a predetermined position of true image coordinates, image coordinates including lens distortion corresponding to the predetermined position (uₜ, vₜ) are found from the foregoing equation (14). Image data representing the image coordinates including lens distortion corresponding to the predetermined position (uₜ, vₜ) shall be image data representing the predetermined position (uₜ, vₜ)

[6] Description of Processing (Image Combining Processing) in Step 5 in FIG. 8

In the image combining processing in the step 5, the first image A1′ and the second image A2′, in which lens distortion has been corrected, obtained in the step 4 are combined on the basis of the first image A1′ and the second image A2′ and the geometric transform matrix Hₙ calculated on the basis of dkₙ (=k) finally found in the step 3.

Although the present invention has been described and illustrated in detail, it is clearly understood that the same is by way of illustration and example only and is not to be taken by way of limitation, the spirit and scope of the present invention being limited only by the terms of the appended claims.

What is claimed:

1. In a lens distortion factor calculating apparatus for subjecting an image picked up by image pick-up means having a lens to lens distortion correction, the lens distortion factor calculating apparatus comprises:
first means for finding, on the basis of two images picked up by the image pick-up means, the coordinates of a plurality of corresponding points between the images;
second means for calculating, on the basis of the coordinates of the corresponding points found by the first means, geometric transform factors between said two images; and
third means for calculating, on the basis of the coordinates of the corresponding points found by the first means and the geometric transform factors found by the second means, a lens distortion factor.

2. The lens distortion factor calculating apparatus according to claim 1, characterized in that the first means comprises
means for extracting an overlapped portion of the two images picked up by the image pick-up means,
means for extracting, from the overlapped portion of one of the images with the other image, a plurality of partial images effective for tracking by an optical flow between both the images as feature points, and
means for tracking a point, which corresponds to each of the feature points on the one image, on the other image on the basis of the optical flow between both the images.

3. In a lens distortion factor calculating method for subjecting an image picked up by image pick-up means having a lens to lens distortion correction, the lens distortion factor calculating method comprises:
a first step of finding, on the basis of two images picked up by the image pick-up means, the coordinates of a plurality of corresponding points between the images;
a second step of calculating, on the basis of the coordinates of the corresponding points found in the first step, geometric transform factors between said two images; and
a third step of calculating, on the basis of the coordinates of the corresponding points found in the first step and the geometric transform factors found in the second step, a lens distortion factor.

4. The lens distortion factor calculating method according to claim 3, characterized in that the first step comprises the steps of
extracting an overlapped portion of the two images picked up by the image pick-up means, extracting, from the overlapped portion of one of the images with the other image, a plurality of partial images effective for tracking by an optical flow between both the images as feature points, and
tracking a point, which corresponds to each of the feature points on the one image, of the other image on the basis of the optical flow between both the images.

5. A computer readable recording medium having a lens distortion factor calculation program for subjecting an image picked up by image pick-up means having a lens to lens distortion correction recorded thereon, wherein the lens distortion factor calculation program causes a computer to carry out:
a first step of finding, on the basis of two images picked up by the image pick-up means, the coordinates of a plurality of corresponding points between the images;
a second step of calculating, on the basis of the coordinates of the corresponding points found in the first step, geometric transform factors between said two images; and
a third step of calculating, on the basis of the coordinates of the corresponding points found in the first step and the geometric transform factors found in the second step, a lens distortion factor.

6. The computer readable recording medium having the lens distortion factor calculation program recorded thereon according to claim 5, characterized in that the first step comprises the steps of
extracting an overlapped portion of the two images picked up by the image pick-up means,
extracting, from the overlapped portion of one of the images with the other image, a plurality of partial images effective for tracking by an optical flow between both the images as feature points, and
tracking a point, which corresponds to each of the feature points on the one image, on the other image on the basis of the optical flow between both the images.

7. In an image constructor for combining a first image and a second image which are picked up by image pick-up means having a lens, the image constructor comprises:
first means for finding, on the basis of the first image and the second image, the coordinates of a plurality of corresponding points between the images;
second means for calculating, on the basis of the coordinates of the corresponding points found by the first means, geometric transform factors between the first image and the second image;
third means for calculating, on the basis of the coordinates of the corresponding points found by the first means and the geometric transform factors found by the second means, a lens distortion factor;
fourth means for subjecting the first image and the second image to lens distortion correction on the basis of the lens distortion factor calculated by the third means; and
fifth means for combining the first image and the second image, which have been subjected to the lens distortion correction, obtained by the fourth means using the geometric transform factors between the first image and the second image which have been subjected to the lens distortion correction.

8. The image constructor according to claim 7 characterized in that the first means comprises
means for extracting an overlapped portion of the first image and the second image,
means for extracting, from the overlapped portion of one of the images with the other image, a plurality of partial images effective for tracking by an optical flow between both the images as feature points, and
means for tracking a point, which corresponds to each of the feature points on the one image, on the other image on the basis of the optical flow between both the images.

9. In an image constructing method for combining a first image and a second image which are picked up by image pick-up means having a lens, the image constructing method comprises:
a first step of finding, on the basis of the first image and the second image, the coordinates of a plurality of corresponding points between the images;
a second step of calculating, on the basis of the coordinates of the corresponding points found in the first step, geometric transform factors between the first image and the second image;
a third step of calculating, on the basis of the coordinates of the corresponding points found in the first step and the geometric transform factors found in the second step, a lens distortion factor;
a fourth step of subjecting the first image and the second image to lens distortion correction on the basis of the lens distortion factor calculated in the third step; and
a fifth step of combining the first image and the second image, which have been subjected to the lens distortion correction, obtained in the fourth step using the geometric transform factor between the first image and the second image which have been subjected to the lens distortion correction.

10. The image constructing method according to claim 9, characterized in that the first step comprises the steps of
extracting an overlapped portion of the first image and the second image,
extracting, from the overlapped portion of one of the images with the other image, a plurality of partial images effective for tracking by an optical flow between both the images as feature points, and
tracking a point, which corresponds to each of the feature points on the one image, on the other image on the basis of the optical flow between both the images.

11. A computer readable recording medium having an image constructing program for combining a first image and a second image which are picked up by image pick-up means having a lens recorded thereon, wherein the image constructing program causes a computer to carry out:
a first step of finding, on the basis of the first image and the second image, the coordinates of a plurality of corresponding points between the images;
a second step of calculating, on the basis of the coordinates of the corresponding points found in the first step, geometric transform factors between the first image and the second image;
a third step of calculating, on the basis of the coordinates of the corresponding points found in the first step and the geometric transform factors found in the second step, a lens distortion factor;
a fourth step of subjecting the first image and the second image to lens distortion correction on the basis of the lens distortion factor calculated in the third step; and
a fifth step of combining the first image and the second image, which have been subjected to the lens distortion correction, obtained in the fourth step using the geometric transform factors between the first image and the second image which have been subjected to the lens distortion correction.

12. The computer readable recording medium having the image constructing program recorded thereon according to claim 11, characterized in that the first step comprises the steps of
extracting an overlapped portion of the first image and the second image,
extracting, from the overlapped portion of one of the images with the other image, a plurality of partial images effective for tracking by an optical flow between both the images as feature points, and
tracking a point, which corresponds to each of the feature points on the one image, on the other image on the basis of the optical flow between both the images.
